(19) United States
(12) Patent Application Publication
(10) Pub. No.: US 2005/0279229 A1
(43) Pub. Date: Dec. 22, 2005

(54) Kettle guard

(75) Inventors: Daniel R. Kroeger, Cincinnati, OH (US); Timothy A. Rhome, Fairfield, OH (US)

Correspondence Address: WOOD, HERRON & EVANS, LLP, 2700 CAREW TOWER, 441 VINE STREET, CINCINNATI, OH, 45202, US

(73) Assignee: Gold Medal Products Co., Cincinnati, OH (US)

(21) Appl. No.: 11/153,593

(22) Filed: Jun. 15, 2005

Related U.S. Application Data
(60) Provisional application No. 60/580,612, filed on Jun. 17, 2004.

(51) Int. Cl. A23L 1/18

(52) U.S. Cl. 99/645

(57) ABSTRACT

A guard defined by a wire-like framework can be mounted on a popcorn kettle to prevent burns from kettle contact. The guard is lightweight, and has resilient connector elements spacing the guard from the kettle.

### PRIORITY CLAIM

Applicant claims the benefit of the filing date of its U.S. provisional patent application entitled “KETTLE GUARD” filed Jun. 17, 2004, U.S. Ser. No. 60/580,612, which entire application is expressly incorporated herein by reference.

### FIELD OF THE INVENTION

The invention relates to safety in the popping of popcorn and more particularly to kettle burn prevention.

### BACKGROUND OF THE INVENTION

In popping popcorn, commercial and larger consumer poppers typically include a chamber in which is suspended a tiltable popping kettle. Popcorn is popped in the kettle and the kettle is tilted to dump popcorn into the chamber, from where it can be removed for container filling and consumption. This typically requires an operator to reach into the chamber to retrieve popped corn. As well, an operator must reach into the chamber to fill the container, such as with unpopped kernels, oil, salt or the like.

Since the kettle is typically hot, contact of the kettle with human anatomy can cause painful and severe burns if due care is not taken.

Accordingly, it has been one objective of the invention to prevent burns from such kettles.

To this end, the invention contemplates a guard, preventing contact with the most exposed or likely-to-burn areas of a hot kettle.

This invention is further appreciated by the following written description of one embodiment and from the drawings thereof, in which:

### BRIEF DESCRIPTION OF THE DRAWINGS

FIG. 1 is a plan view of a kettle guard according to the invention;

FIG. 2 is an end view of the guard in FIG. 2; and

FIG. 3 is a perspective illustration of the guard of FIG. 1 in place on a popcorn kettle.

### DETAILED DESCRIPTION OF THE PREFERRED EMBODIMENT

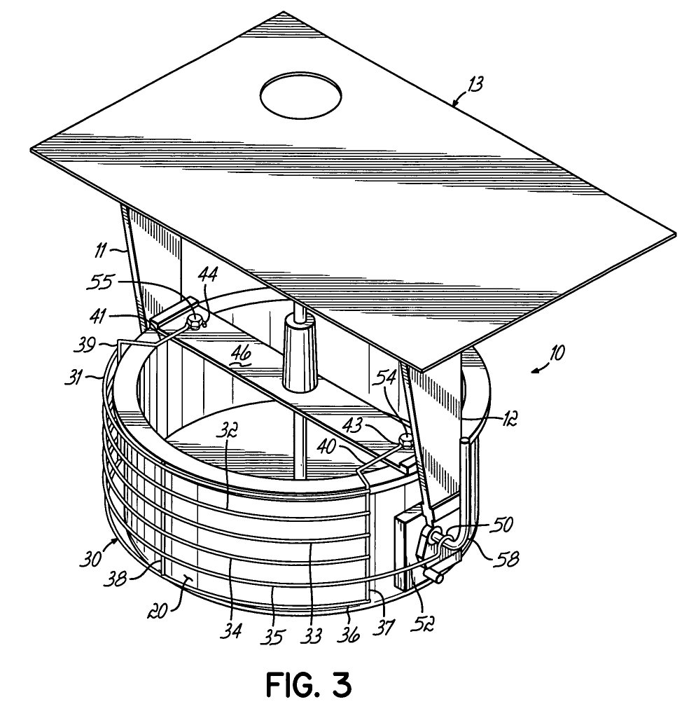

Turning now to FIG. 3, a tiltable, popping kettle 10 is suspended on brackets 11, 12 from a frame member 13 of a popcorn popper. The popper preferably comprises a cabinet defining a chamber (not shown) into which popcorn is dumped from kettle 10.

As suggested in FIG. 3, the side 20 of kettle 10 is oriented so that it faces the open area of such a chamber into which an operator gains access to dump or remove popped corn or to load the kettle. The back side (not shown) of the kettle 10, and which is opposite front side 20, is typically oriented near a rear side or corner of the cabinet so its position does not present the user hazard which side 20 does, facing the open or accessible area of the cabinet or chamber.

According to the invention, a kettle guard 30 is oriented preferably about the side 20 of the kettle, extending about 180 degrees therearound in a circular direction, although the degree of extension can be varied. Guard 30 includes a series of barrier wires 31-36 (FIG. 2) disposed in a generally circular direction and with a slightly greater radius than that of the outside surface, such as side 20, of kettle 10 with which the guard will be used. Four, five or any appropriate number of wires extending similarly to wires 31-36 can be used as necessary. The Figures illustrate six such wires.

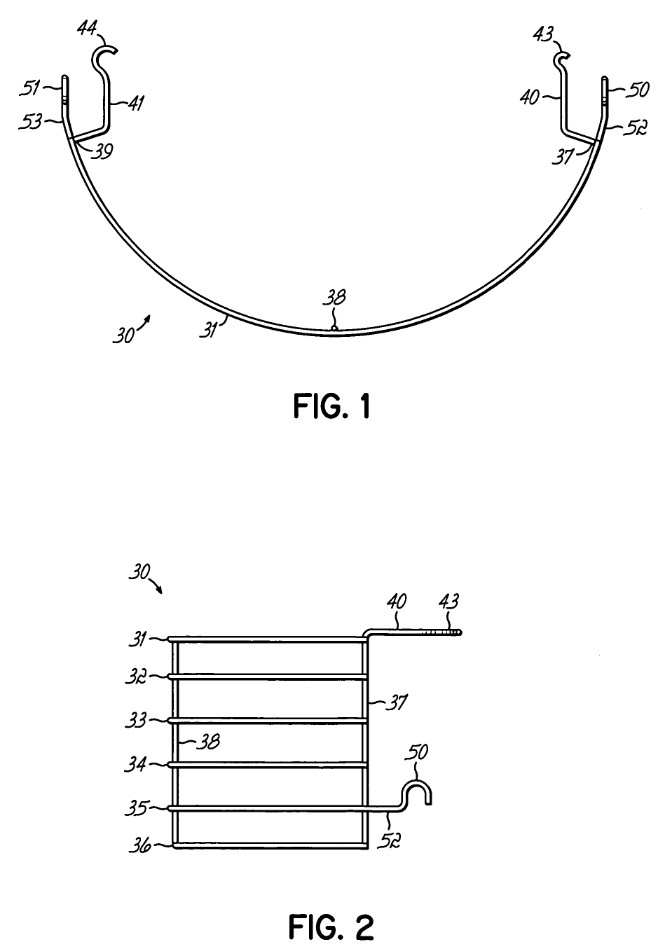

Vertical support wires, such as at 37-39 (FIGS. 1-3) provide a support for wires 31-36, which are attached thereto by any suitable means, as shown. Wire 36 is preferably attached to wires 37-39 at and under the ends thereof, as shown in FIG. 2.

The upper ends 40, 41 of wires 37, 39 are extended at right angles to the other portions of those wires and radially inward of the circular direction of extension of wires 31-36. Ends 40, 41 terminate in open hooks or loops 43, 44. These hooks have open sides opening in the same direction as shown.

Wire. 35 includes hooks or loops 50, 51 at respective ends 52, 53 of wire 35. Hooks 50, 51 extend in the similar circular direction as wires 31-36 and are open downwardly in a 90 degree direction to that of the open sides of hooks 43, 44.

The wire elements of guard 30 are interconnected by any suitable joining technology such as brazing or welding or any other suitable process. Moreover, it will be appreciated that while the wires are preferably of stainless steel, they can be of any suitable metal or non-metal material.

The guard 30 is mounted to any suitable structure associated with the kettle, such as, in one embodiment, a brace 46 extending across the kettle. The brace 46 is provided with headed bolts or fasteners, such as a hex-headed screw 54, 55 at each end thereof proximate the location of the center of hooks 43, 44. In use, these screws 54, 55 are placed near the location of the developed position of loops or hooks 43, 44. The screws 54, 55 can be assembled to brace 46 and the hooks 43, 44 then maneuvered around and over the heads by virtue of their shape and by virtue of the resiliency of wire ends 40, 41. The hooks 43, 44 fit under the screw heads and hold the guard 30 in place.

Also, the hooks 50, 51 can be maneuvered over pins 58 (FIG. 3) which may be the kettle pivot or trunnion pins or the kettle stop pins positioning the kettle. Hooks 50, 51 serve to position guard 30 so that it is uniformly positioned about, and spaced away from, kettle 10. They aid the guard 30 in resisting radially inward movement toward the kettle 10. This helps to prevent compression of the guard 30 inwardly toward the kettle 10 by inadvertent contact with the guard 30 by an operator.

When so mounted, the guard 30 contacts any kettle associated structure only at the area of contact with hooks 43, 44 an the distal ends of wire extensions 40, 41 and at hooks 50, 51 extending from wire 35 at respective ends 52, 53 thereof. Heat transfer into the guard 30, by conduction, is thus limited and the guard remains much cooler than the kettle 10.

Inadvertent contact with the guard thus protects an operator against burns which may otherwise result from direct kettle contact.

It should be appreciated that the wire components of the guard 30 can be oriented about a hot kettle 10 in multiple positions to provide guarding suitable to prevent inadvertent contact with a hot kettle 10. Thus, the guard 30 could have components further surrounding the kettle 10, be disposed adjacent or proximate its bottom, or otherwise oriented to obstruct undesired contact by an operator.

Moreover, it should be appreciated that while metallic wires are disclosed as semi-annular components around the kettle 10, other shapes of guard 30 components and other component materials can be used for the guard, solely or in a variety of combinations as may be desired.

Also, it will be appreciated that the preferably open loops or hooks 43, 44 and 50, 51, being resiliently mounted by virtue of the wire structure of the guard 30, are easily installed onto a kettle, or easily removed therefrom for cleaning or the like.

Use of the guard 30 advantageously prevents burns from inadvertent contact with kettle 10.

These and other objects and advantages will be readily apparent to those of ordinary skill in the art without departing from the scope of the invention and applicant intends to be bound only by the claims appended hereto.

1. A kettle guard for a popcorn kettle mounted in a cabinet and comprising:
a guard for disposition about a selected area of a kettle;
said guard having connecting members extending therefrom for connection thereof to structure operatively associated with said kettle;
said connecting members spacing said guard from any kettle with which said guard is mounted.

2. A kettle guard as in claim 1 wherein said guard is comprised of a framework of wire elements.

3. A kettle guard as in claim 2 wherein said connecting members comprise hooks extending from at least one of said wire elements.

4. A kettle guard as in claim 3 wherein said hooks extend from distal ends of wire elements disposed transversely to other wire elements of said guard.

5. A kettle guard as in claim 4 further including additional kettle positioning hooks extending from at least one of said other wire elements of said guard.

6. A kettle guard as in claim 1, said guard further comprising:
a plurality of wire elements, each extending in a circular direction adjacent to and spaced from other similarly extending wire elements;
at least two wire elements extending transversely to said plurality of wire elements and connected thereto;
a hook at the end of each of said at least two wire elements, each said hook respectively mounted on respective extensions of said at least two wire elements, said extensions extending radially inwardly of said circular direction.

7. A kettle guard as in claim 6 further including a hook disposed at the end of one of said plurality of wire elements, said hook extending approximately in said circular direction.

8. A kettle guard as in claim 6 wherein said hooks each comprise hook openings oriented open toward the same direction.

9. A kettle guard as in claim 8 wherein said hook is open in a direction at 90 degrees to the opening of said hook openings oriented open in the same direction.

10. A kettle guard as in claim 1 including the combination of said guard with a kettle, said connecting members supporting said guard in a position spaced from surfaces of said kettle.
